(19) United States
(12) Patent Application Publication
(10) Pub. No.: US 2006/0139297 A1
(43) Pub. Date: Jun. 29, 2006

(54) Display for mobile phone

(76) Inventors: Esa-Sakari Maatta, Viiala (FI); Timo Herranen, Viiala (FI)

Correspondence Address: PERMAN & GREEN, 425 POST ROAD, FAIRFIELD, CT, 06824, US

(21) Appl. No.: 11/025,254

(22) Filed: Dec. 29, 2004

(51) Int. Cl. G09G 3/36

(52) U.S. Cl. 345/102

(57) ABSTRACT

A mobile communication apparatus including a display unit, wherein the display unit includes a first and a second display arranged back-to-back, a light source, and a single reflective layer arranged between the first display and the second display is disclosed. Each of the first and second displays includes a light guide arranged to transmit light from the light source to backlight the displays.

### BACKGROUND OF THE INVENTION

1. Field of the Invention

The present invention relates to a mobile communication apparatus, a display unit and a backlighting arrangement.

2. Brief Description of Related Developments

Mobile communication apparatuses, e.g. mobile phones, with dual displays are attractive to users, and especially used in folding phones, also called clamshell phones. In these kinds of apparatuses, it is a desire to keep the thickness of the apparatus down, and thus the thickness of the displays. However, there is a problem when two displays are built together: either the thickness of the two displays, arranged back-to-back, increases, or, when arranging them back-to-back with a common backlighting arrangement, there is an unwanted effect where surrounding light, especially in sunlight, is transmitted through the two displays.

### SUMMARY OF THE INVENTION

It is therefore an object of the present invention to provide a mobile communication apparatus with a display arrangement in which the above mentioned unwanted effects are reduced.

The above object is achieved according to a first aspect of the present invention by a mobile communication apparatus comprising a display unit, wherein the display unit comprises a first and a second display arranged back-to-back, a light source, and a single reflective layer arranged between the first display and the second display, wherein each of the first and second display comprises a light guide arranged to transmit light from the light source to backlight the displays.

In this context, ‘back-to-back’ should be construed such that the sides of the displays that a user faces are directed outwards and the opposite sides of the displays are adjacent to each other. ‘First’ and ‘second’ should be construed to separate different elements and not as a timing parameter.

An advantage of this is that a mobile communication apparatus with dual displays can be built with lower thickness without a risk for interference due to leaking light from one of the displays to the other.

The first and second displays may be arranged with their light guides up to said reflective layer. An advantage of this is compact structure in combination with good backlighting.

The first and second displays may comprise a light enhancement layer arranged between the light guide and liquid crystal cells of the displays.

The display unit may further comprise a common light guide arranged to transmit light from the light source to the light guides of the first and second displays. An advantage of this is further compact structure. The light guide of the first display may comprise the common light guide.

The first display may be arranged to be visible at one end of a body of the moblile communication apparatus, and the second display may be arranged to be visible at an opposite side of the body. The body may be arranged to be foldable to another body of the mobile communication apparatus.

The above object is achieved according to a second aspect of the present invention by a display unit comprising a first and a second display arranged back-to-back, a light source, and a single reflective layer arranged between the first display and the second display, wherein each of the first and second displays comprises a light guide arranged to transmit light from the light source to backlight the displays.

The first and second displays may be arranged with their light guides up to said reflective layer. The first and second displays may comprise a light enhancement layer arranged between the light guide and liquid crystal cells of the displays. The display unit may further comprise a common light guide arranged to transmit light from the light source to the light guides of the first and second displays. The light guide of the first display may comprise the common light guide.

The above object is achieved according to a third aspect of the present invention by a backlighting arrangement for a dual back-to-back display unit, comprising a light source, a first and a second light guide arranged to transmit light from the light source to backlight displays of the display unit, and a reflective layer arranged between the first light guide and the second light guide.

The backlighting arrangement may further comprise a common light guide arranged to transmit light from the light source to the first and second light guides. The light guide of said first display may comprise the common light guide.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, wherein:

FIG. 1 is a block diagram schematically showing a mobile communication apparatus;

FIGS. 2a and 2b shows different views of a mobile communication apparatus;

FIG. 3 is a sectional view of a display according to one embodiment of the present invention; and

FIG. 4 is a sectional view of a display according to another embodiment of the present invention.

### DETAILED DESCRIPTION OF THE PREFERRED EMBODIMENTS

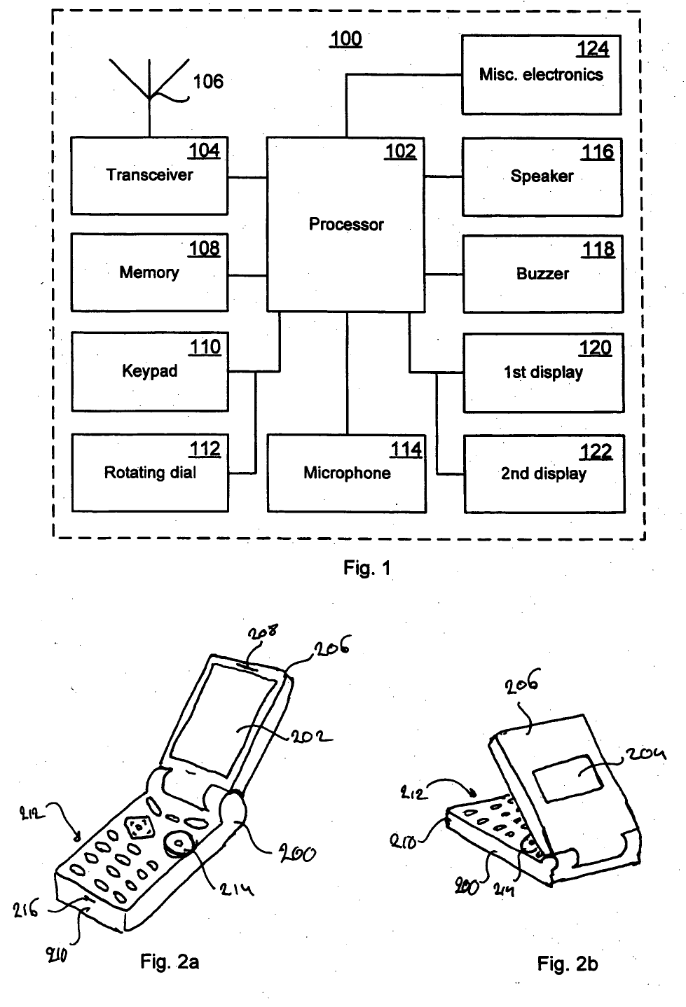

FIG. 1 is a block diagram schematically showing a mobile communication apparatus 100 according to an embodiment of the present invention. The mobile communication apparatus 100 comprises a processor 102 which is arranged to control functions of the mobile communication apparatus 100. The mobile communication apparatus 100 further comprises a transceiver 104 connected to the processor 102 which is arranged to receive and transmit radio signals through an antenna 106. The processor 102 can further be connected to a memory 108, a keypad 110, a rotating dial 112, a microphone 114, a speaker 116, a buzzer 118, a first display 120 and a second display 122. Further miscellaneous electronics 124, such as means for infrared data association (not shown), can also be connected to the the processor.

FIGS. 2a and 2b shows a mobile communication apparatus 200, from different view angles, comprising a first display 202 and a second display 204 visible at opposite sides of a first body 206 of the mobile communication apparatus 200. Further, the mobile communication apparatus 200 is provided with a speaker 208 arranged in the first body 206. On a second body 210 of the mobile communication apparatus 200, keys 212, a rotating dial 214 and a microphone 216 are provided. A processor, memory, radio electronics and other electronics (not shown) are also provided in the second body 210. However, the keys 212, rotating input dial 214, speaker 208, microphone 216, processor, memory, radio electronics, and other electronics could be arranged in any other suitable way in the first or second bodies 206, 210 of the mobile communication apparatus 200.

The two bodies 206, 210 are foldable in relation to each other to form a so called clamshell structure. When the two bodies 206, 210 are folded up, the second display 204 is visible, and when the bodies 206, 210 are unfolded, also the first display 202 is visible.

When the mobile communication apparatus 200 is folded up, as is normal when the mobile communication apparatus 200 is in stand-by mode and is carried in a pocket or a purse, the thickness of the mobile communication apparatus 200 is the aggregated thickness of the two bodies 206, 210. It is a desire to keep this thickness low to enable easy carrying of the mobile communication apparatus 200. To keep the thickness of the first body 206 low, a display unit according to the present invention is used.

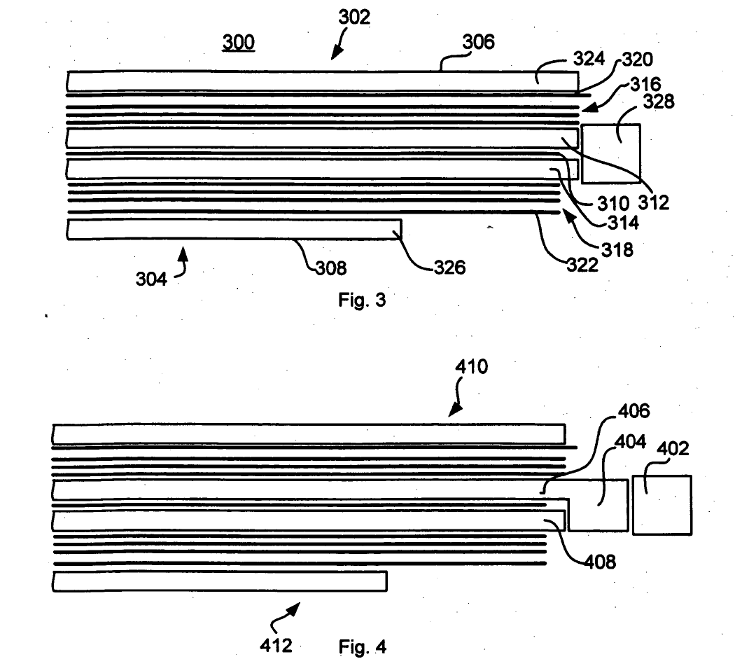

FIG. 3 is a sectional view of a part of a display unit 300 according to one embodiment of the present invention. The display unit 300 comprises a first display 302 and a second display 304, with their display areas 306, 308 directed in opposite directions. Between the displays 302, 304, a reflective layer 310 is provided. Each of the displays 302, 304 comprises, counted from the reflective layer 310, a light guide 312, 314, light enhancement sheets 316, 318, a rim sheet 320, 322 and a display glass panel 324, 326. The light guides 312, 314 provide backlighting by transmitting light from a light source 328 and emitting the light through the displays 320, 304. The thickness of the first body of the mobile communication apparatus can be kept low because the display unit 300 only need one common reflective layer 310, and the two displays 302, 304 are provided up to each other. Further, space is saved since only one light source 328 is used for both displays 302, 304. The two displays 302, 304 are manufactured as one display unit 300, which carry with it many advantages, such as lower costs, improved logistics, improved assembly of the mobile communication apparatus, etc.

The two light guides 312, 314 reach the light source 328, which can be one or more light emitting diodes (LED). The light from the light source 328 is then transmitted by the light guides 312, 314 to the displays 302, 304, and then the light is then backlighting the displays 302, 304, respectively.

According to another embodiment of the present invention, as depicted in FIG. 4, light from a light source 402 is transmitted through a common light guide 404, and then divided between a first light guide 406 and a second light guide 408 of a first display 410 and a second display 412. The common light guide 404 can be formed as a part of the first light guide 406, which is formed to transmit the light from the light source 402 and transmit a part of the light to the second light guide 408. Of course, the common light guide can also be formed as a part of the second light guide 408, which is then formed to transmit the light from the light source 402 and transmit a part of the light to the other light guide 406.

1. A mobile communication apparatus comprising a display unit, wherein said display unit comprises a first and a second display arranged back-to-back, a light source, and a single reflective layer arranged between said first display and said second display, wherein each of said first and second display comprises a light guide arranged to transmit light from said light source to backlight said displays.

2. The mobile communication apparatus according to claim 1, wherein said first and second displays are arranged with their light guides up to said reflective layer.

3. The mobile communication apparatus according to claim 1, wherein said first and second displays comprise a light enhancement layer arranged between said light guide and liquid crystal cells of said displays.

4. The mobile communication apparatus according to claim 1, wherein said display unit further comprises a common light guide arranged to transmit light from said light source to said light guides of said first and second displays.

5. The mobile communication apparatus according to claim 4, wherein said light guide of said first display comprises said common light guide.

6. The mobile communicatio apparatus according to claim 1, wherein said first display is arranged to be visible at one end of a body of said moblile communication apparatus, and said second display is arranged to be visible at an opposite side of said body.

7. The mobile communication apparatus according to claim 6, wherein said body is arranged to be foldable to another body of said mobile communication apparatus.

8. A display unit comprising a first and a second display arranged back-to-back, a light source, and a single reflective layer arranged between said first display and said second display, wherein each of said first and second display comprises a light guide arranged to transmit light from said light source to backlight said displays.

9. The display unit according to claim 8, wherein said first and second displays are arranged with their light guides up to said reflective layer.

10. The display unit according to claim 8, wherein said first and second displays comprise a light enhancement layer arranged between said light guide and liquid crystal cells of said displays.

11. The display unit according to claim 8, wherein said display unit further comprises a common light guide arranged to transmit light from said light source to said light guides of said first and second displays.

12. The display unit according to claim 11, wherein said light guide of said first display comprises said common light guide.

13. A backlighting arrangement for a dual back-to-back display unit, comprising a light source, a first and a second light guide arranged to transmit light from said light source to backlight displays of said display unit, and a reflective layer arranged between said first light guide and said second light guide.

14. The backlighting arrangement according to claim 13, further comprising a common light guide arranged to transmit light from said light source to said first and second light guides.

15. The backlighting arrangement according to claim 14, wherein said light guide of said first display comprises said common light guide.
